(19) United States
(12) Patent Application Publication
(10) Pub. No.: US 2021/0108397 A1
(43) Pub. Date: Apr. 15, 2021

(54) SUPPLY ARM WITH BUILT-IN REGULATOR FOR SHOWER HEAD

(71) Applicant: Marco Antonio GARCIA VILLAREAL, Monterrey (MX)

(72) Inventor: Marco Antonio GARCIA VILLAREAL, Monterrey (MX)

(21) Appl. No.: 17/055,593

(22) PCT Filed: May 17, 2018
(86) PCT No.: PCT/MX2018/000046

§ 371 Date: Nov. 15, 2020

(51) Int. Cl. E03C 1/02; B05B 1/18; B05B 1/30

(52) U.S. Cl. CPC E03C 1/025; E03C 2001/026; B05B 1/3026; B05B 1/18

(57) ABSTRACT

Shower arm with an integrated regulator for shower head, which is capable of controlling the water flow that exits from the shower head via the regulator bolt with lever inserted in the body of the regulator. This arm is connected to the water supply pipe of the shower room via a nipple connection that is attached to the shower arm based on a metallic tube that, at its other end, incorporates a nipple union in which the body of the water flow regulator is attached. The regulator bolt allows you to reduce the water flow to the maximum and, because of its type of coupling, it is expressly designed to receive the Spherical Shower Head which is the object of international patent application PCT/MX/2018/000032 and that, via a standard universal male thread adapter, any shower head can be fitted. Both, the adapter and the shower head, maintain airtightness due to the seal gaskets placed in the circular slot of the regulator body and in the corresponding circular slot of the universal adapter, avoiding the use of seal tape.

### FIELD OF THE INVENTION

This invention refers to a shower arm for shower head, which integrates a regulator. More particularly, this invention refers to a shower arm with water flow regulator integrated preferably to be used for the Spherical Shower Head described in international patent application No. PCT/MX2018/000032, being even able to be used with any shower head since its coupling form is universal.

### BACKGROUND OF THE INVENTION

Shower heads should invariably be connected to a shower arm, which is a pipe that connects to the water supply pipe of a shower room. This arm has not changed its shape or characteristics since the beginning of the usage of shower rooms and it consists of only one piece where water flows and where a shower head is attached.

Some patents are cited below that show a shower arm for shower head commonly used, patents U.S. Pat. Nos. 3,112,073, 3,231,200, 5,218,956, 5,241,714, 5,356,077, 9,393,578; in these patents it can be seen how, in the description, the shower arm is only a conduit through which water can flow, without offering absolutely any other function, being so obvious its function of conducting the water, that some patents do not even talk about the arm and its importance.

It is incredible, and it is worth highlighting the lack of interest and importance that manufacturers and designers of shower arms for shower heads have given it worldwide, by dismissing the very important integration of a water flow regulator to the mentioned device.

It is also noteworthy and more surprising that there are very few manufacturers and designers of shower heads worldwide who are interested and include a water flow regulation system in their designs, being very rare and very isolated to find in the market shower heads that have such a regulator device.

Therefore, the present patent application transforms what has traditionally been a simple shower arm for shower head into what is now offered as an improved novelty, based on the fact that having a water flow regulator integrated to the arm as a whole, could guarantee incalculable savings in the user's water usage. As well as having the option of solving the problem that represents the very uncomfortable situation of having on top or to one side permanently the rain of water during the whole time the user takes to shower, being able in a very simple way to avoid unnecessary water waste when using this regulator device integrated in the shower arm.

The problem described above is solved decisively by the technological contribution of this new shower arm with an integrated regulator for shower head because it solves the problem by incorporating the water flow regulator in that device.

### BRIEF SUMMARY OF THE INVENTION

The present invention is directed to a shower arm for shower head which integrates at one end a water flow regulator including a universal thread for coupling the Spherical Shower Head, which is the object of international patent application PCT/MX2018/000032, in which the body of the water flow regulator is integrated into the shower arm via a nipple joint, and also includes in that body a universal adapter which is the converter element for coupling to any standard shower head; At the other end of the arm there is a nipple connection with standard universal thread which is the one that is attached to the shower room water supply pipe and is tightened by the body in a hexagonal way and is connected to the supply arm through an orifice of a diameter slightly larger than the outer diameter of the pipe to which it was welded.

The water flow regulator consists of a body that integrates a bolt with a lever, this bolt incorporates a pair of seals that prevent water leakage and a lock that prevents the lateral movement of the bolt in the body of the regulator, this bolt can be rotated on its axis via the lever to regulate the water flow, the correspondence of the previous hole of the bolt with the hole of the regulator's body, it allows a complete flow, being possible through a lever, to turn the bolt to regulate the flow and control the water expense at the exit, being able to position and to specify the water expense in intermediate values between the maximum expense and the minimum expense, even to reduce or to increase the flow from a maximum to a minimum or from a minimum to a maximum in an instantaneous form only with a simple turn of 90° of the lever.

This shower arm invention is preferably designed to be used with the Spherical Shower Head described in the international patent application PCT/MX2018/000032, and can even be used with any other conventional shower head via the universal adapter which is also part of the claimed invention.

### BRIEF DESCRIPTION OF THE DRAWINGS

FIG. 1 is a side view of the shower arm with an integrated regulator including the Spherical Shower Head which is the object of international patent application PCT/MX2018/000032.

FIG. 2 is a front view of the water flow regulator of the shower arm with an integrated regulator for the Spherical Shower Head, object of international patent application PCT/MX2018/000032.

FIG. 3 is a side view of the water flow regulator of the shower arm with an integrated regulator for the Spherical Shower Head, object of international patent application PCT/MX2018/000032.

FIG. 4 is a side view in section A-A of the body of the water flow regulator of the shower arm with an integrated regulator for the Spherical Shower Head, object of the international patent application PCT/MX2018/000032.

FIG. 5 is a front view of the water flow regulator of the shower arm with an integrated regulator including the Spherical Shower Head, object of the international patent application PCT/MX2018/000032

FIG. 6 is a partially exploded isometric view of the coupling of the Spherical Shower Head, object of the international patent application PCT/MX2018/000032, with the water flow regulator of the shower arm.

FIG. 7 is a partially exploded isometric view of the coupling of a flat shower head with the water flow regulator of the shower arm.

FIG. 8 is a front view of the nipple joint that connects the shower arm to the body of the water flow regulator.

FIG. 9 is a top view of the nipple joint that connects the shower arm to the body of the water flow regulator.

FIG. 10 is a side view of the B-B section of the nipple joint that connects the shower arm to the body of the water flow regulator.

FIG. 11 is a side view of the shower arm.

FIG. 12 is a front view of the nipple connection of the shower arm with an integrated regulator for shower head.

FIG. 13 is a top view of the nipple connection of the shower arm with an integrated regulator for shower head.

FIG. 14 is a front view of the C-C section of the nipple connection of the shower arm with an integrated regulator for shower head.

FIG. 15 is front view of the regulator bolt.

FIG. 16 is a side view of the regulator bolt.

FIG. 17 is a side view of the D-D section of the regulator bolt.

FIG. 18 is a side view of the regulator bolt lever.

FIG. 19 is a top view of the shower arm with an integrated regulator for shower head,

FIG. 20 is a side view of the E-E section of the shower arm with an integrated regulator for shower head.

FIG. 21 is a front view of the universal adapter of the shower arm with an integrated regulator for shower head.

FIG. 22 is a top view of the universal adapter of the shower arm with an integrated regulator for shower head.

FIG. 23 is an F-F section view of the universal adapter of the shower arm with an integrated regulator for shower head.

FIG. 24 is a bottom view of the universal adapter of the shower arm with an integrated regulator for shower head.

FIG. 25 is a front view of the water flow regulator of the shower arm with an integrated regulator with the universal adapter and a conventional shower head attached to it.

FIG. 26 is a partially exploded isometric view of the universal adapter coupling and a conventional shower head with the shower arm's water flow regulator.

FIG. 27 is an exploded isometric view of the shower arm with an integrated regulator with its universal adapter for shower head.

FIG. 28 is an isometric view of the shower arm with an integrated regulator with its universal adapter for shower head.

### DETAILED DESCRIPTION OF THE DRAWINGS

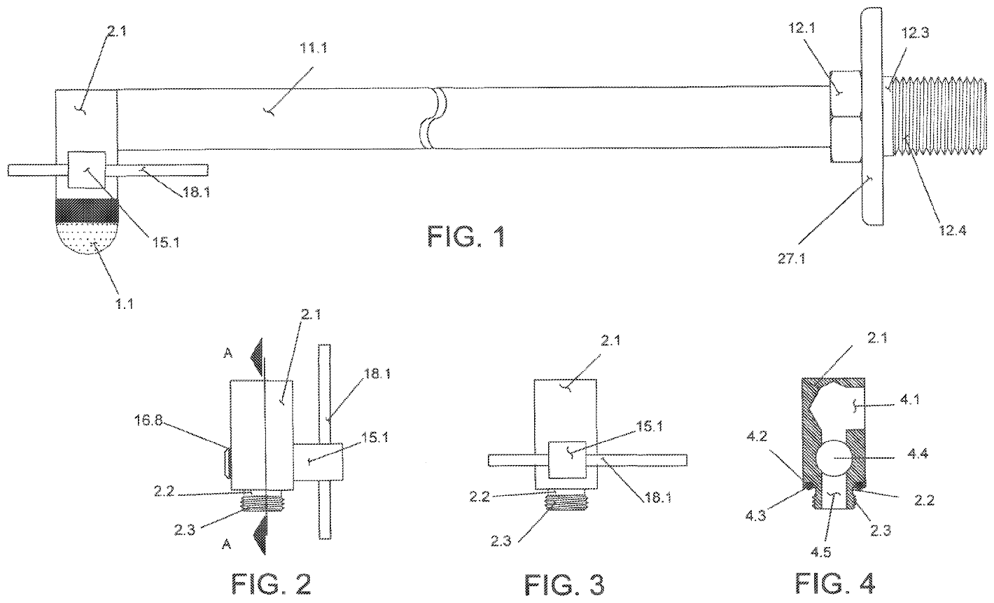

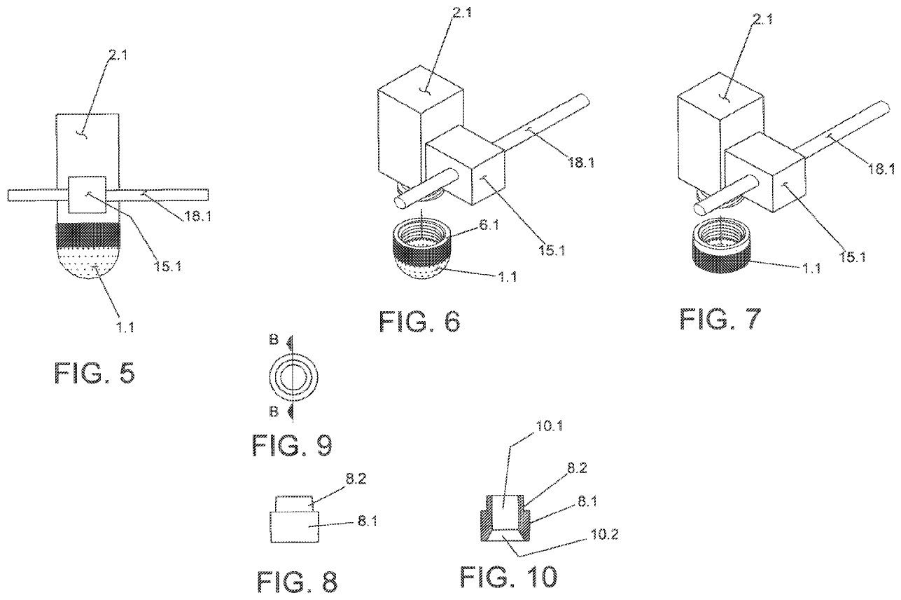

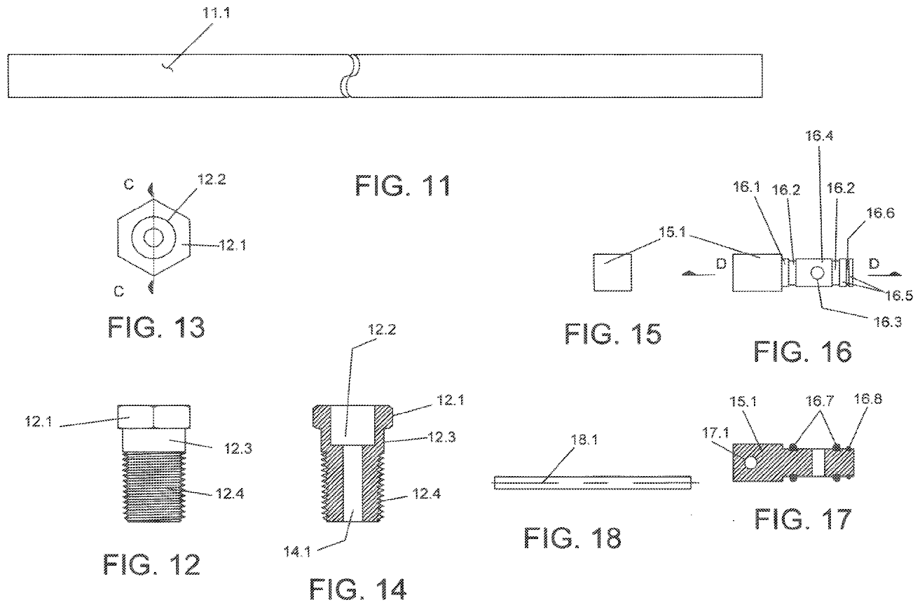

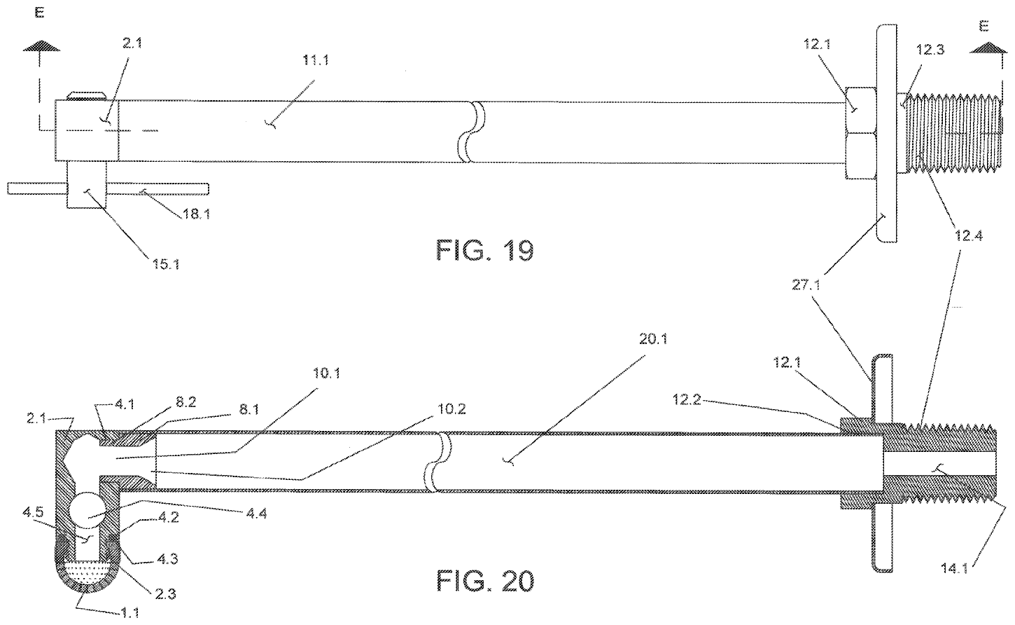

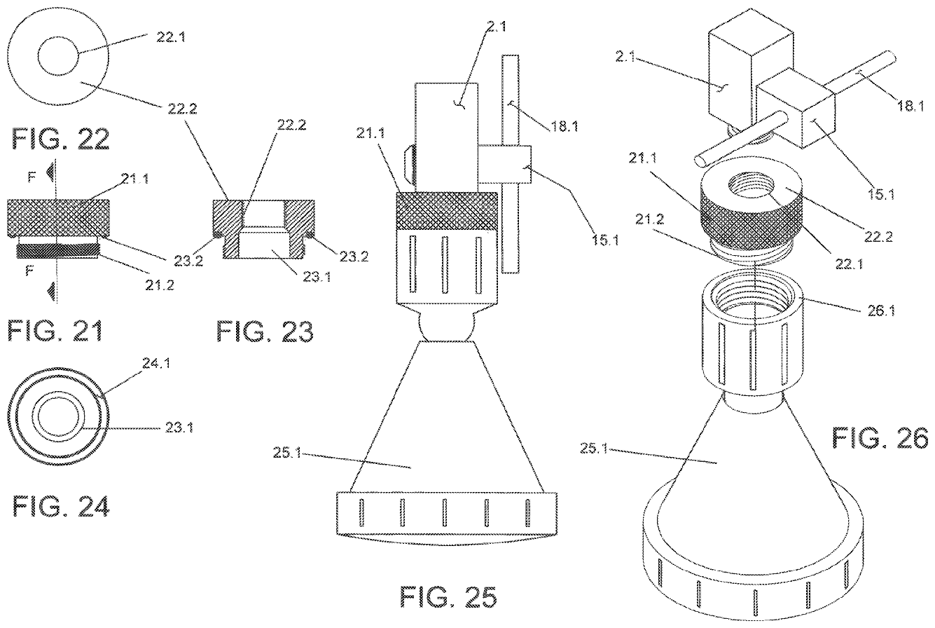

The present invention refers to a shower arm with an integrated regulator for shower head, preferably made out of brass under the machining process, joined by welding or threading, it could be made of any other material and it consists of a tube or shower arm (11.1, FIG. 11), a water flow regulator (2.1 in FIGS. 2, 3 and 4) a regulator bolt (15.1 in FIGS. 15, 16 and 17), a nipple connection (12.3 in FIGS. 12, 13 and 14), a universal adapter (21.1 in FIGS. 21, 22, 23 and 24) and a Spherical Shower Head (1.1 in FIGS. 1, 5, 6 and 20) which is the object of international patent application PCT/MX2018/000032.

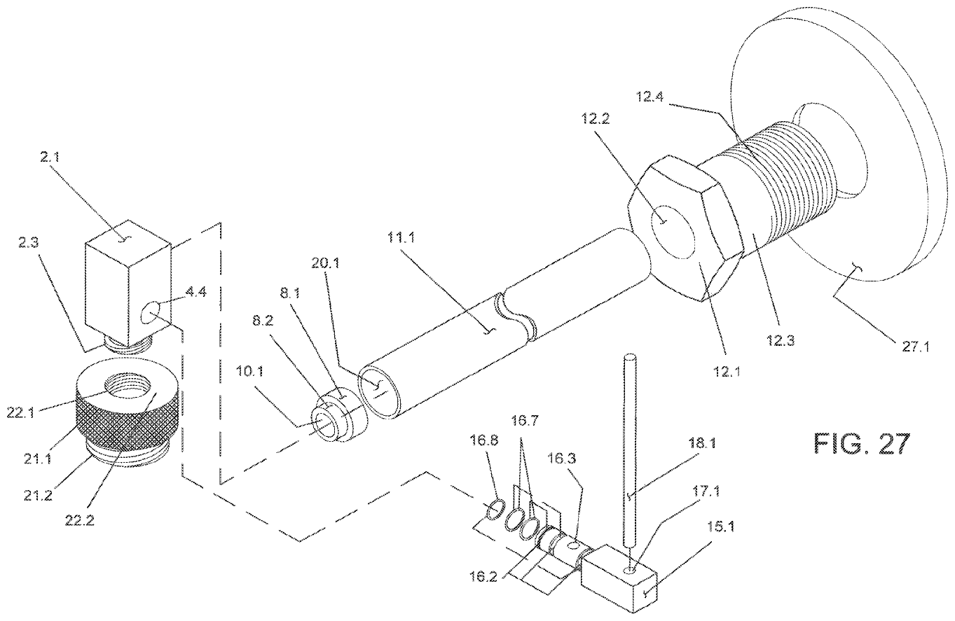

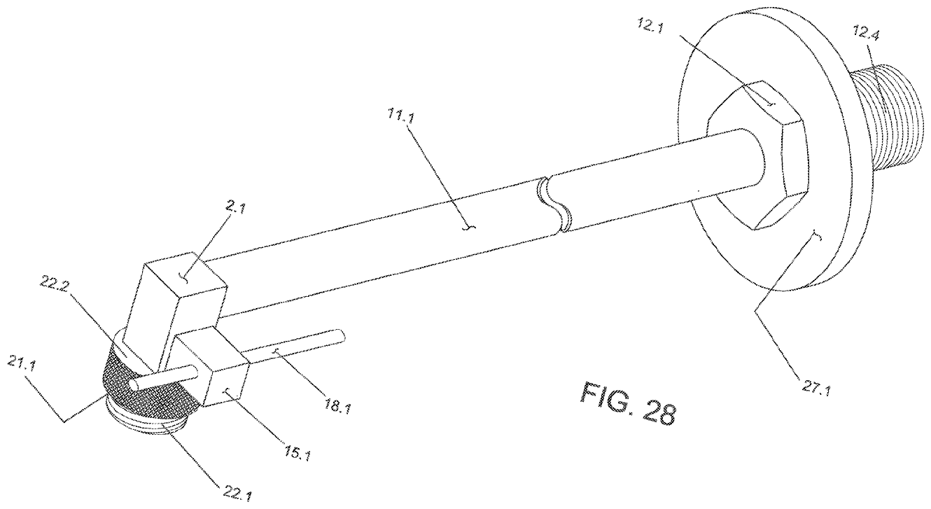

At one end, the shower arm (11.1) is joined to the nipple connection (12.3) in the hole (12.2 of FIGS. 14, 20 and 27) where the shower tube (11.1) is introduced as shown in (FIG. 20) and is welded together, the nipple connection (12.3) is connected to the water supply pipe via the thread (12.4), which is tightened by the hexagonal body (12.1) of the nipple connection (12.3) and receives the splice (27.1).

The shower arm (11.1) is connected to the water flow regulator (2.1) via a nipple (FIGS. 8, 9 and 10). This nipple is inserted in the hole (20.1) of the shower arm (11.1) via the bolt (8.1) and in the hole (4.1) of the regulator body (2.1) via the bolt (8.2) and is welded as shown in (FIG. 20), this water flow regulator (2.1) has a circular slot (4.2) where a gasket (4.3) is accommodate. It also has a recessed hole (4.4) where the regulator bolt (15.1 in FIGS. 15, 16, and 17) is inserted, with recessed holes (16.3) for the water to pass through and (17.1) for the lever (18.1) with two circular slots (16.2) where two gaskets (16.7) are placed to avoid water leakage, and another slot (16.6) to be able to accommodate a padlock (16.8) that serves as a stop to position and avoid lateral movement of the regulator bolt (15.1) and can be rotated on its axis when the lever (18.1) is turned to align the hole (16.3) with the hole (4.5), the one that as it is turned, the water flow is decreased or increased, that flows through the interior of the arm (20.1) and that reaches the conduit (10.1 and 10.2) of the nipple union (FIGS. 8, 9 and 10), passing through the conduit (4.1) of the water flow regulator body (2.1), changing 90° the direction of the water flow through the hose (4.5) that is the only one that communicates with the hose (16.3), this body adds a male thread (2.3) that receives to a Spherical Shower Head (1.1), object of the international application of patent PCT/MX2018/000032, that incorporates a circular slot (4.2) sealing by the gasket (4.3) the one that this in correspondence with the surface (6.1) of the Spherical Shower Head (1.1), from where the water coming from the supply network exits.

The shower arm with an integrated regulator for shower head has a universal adapter (FIGS. 21, 22 and 23) with a knurled surface on the top (21.1) so that the user can screw in the universal adapter (FIGS. 21, 22, 23 and 24) using the universal female thread (22.1) to the male thread (2.3) of the water flow regulator (2,1), the universal adapter (FIGS. 21, 22, 23 and 24) has one side (22.2) that is in correspondence with the gasket (4.3), which seals this surface preventing water from leaking, as well as the universal adapter (FIGS. 21, 22, 23 and 24) incorporates a universal male thread (21,2) which receives the female thread of the shower head (25.1) or any other shower head, the shower head seals when the surface (26.1) of the shower head (25.1) is fitted to the gasket (23.2) contained in the slot (24.1) to prevent water leakage, the adjustment of the universal adapter as well as the shower head is easily done by hand without the use of tools, achieving an airtight seal avoiding the use of sealing tape, this adapter works to place any type of shower head (25.1, FIGS. 25 and 26).

The incorporation of the regulator in the shower arm allows the life of the shower handle gaskets to be extended, since by controlling the water flow directly with the regulator, it is not necessary to manipulate the handles during showering. In addition, the user can maintain the temperature of the shower water, since once the temperature has been calibrated on the handles, the user can control the flow via the regulator in the shower arm, leaving the water temperature intact.

1. Shower arm with an integrated regulator for shower head, essentially characterized by comprising at one end a nipple connection attached to the shower arm by welding and at the other end of the shower arm an inner nipple connection connecting the body of the water flow regulator to the mentioned welded arm, the body of the water flow regulator incorporates a regulator bolt with lever and a universal adapter for shower head is connected to that body.

2. Shower arm with an integrated regulator for shower head, in accordance with claim 1, essentially characterized by containing a water flow regulator body which integrates the regulator bolt with lever.

3. Shower arm with an integrated regulator for shower head in accordance with claim 1, essentially characterized by incorporating a conventional universal adapter for shower head.

4. Shower arm with an integrated regulator for shower head, according to claim 1, essentially characterized because the body of the water flow regulator integrates a universal thread to place the universal adapter or shower head.

5. Shower arm with an integrated regulator for shower head, according to claim 1, essentially characterized by containing a gasket in the circular slot of the body of the water flow regulator which seals either with the universal adapter or with a shower head.

6. Shower arm with an integrated regulator for shower head, according to claim 1, essentially characterized by containing a gasket in the circular slot of the universal adapter which is in correspondence with the shower head preventing water leakage.

7. Shower arm with an integrated regulator for shower head, according to claim 1, essentially characterized by incorporating a nipple connection that is screwed into the water supply pipe and tightened by its hexagonal body.

8. Shower arm with an integrated regulator for shower head, according to claim 2, essentially characterized by the fact that the flow regulator bolt can reduce the water flow to the maximum.

9. Shower arm with an integrated regulator for shower head, in accordance with claim 5, essentially characterized because the gaskets on the body of the regulator and on the universal adapter avow the hermetic seal without sealing tape needed.
